(19) United States
(12) Patent Application Publication
(10) Pub. No.: US 2025/0299894 A1
(43) Pub. Date: Sep. 25, 2025

(54) KEYSWITCH

(71) Applicant: DARFON ELECTRONICS CORP., Taoyuan City (TW)

(72) Inventors: Po-Min Huang, Taoyuan City (TW); Po-Wei Tsai, Taoyuan City (TW); Kuei-Lin Teng, Taoyuan City (TW); Wun-Huei Wang, Taoyuan City (TW)

(73) Assignee: DARFON ELECTRONICS CORP., Taoyuan City (TW)

(21) Appl. No.: 19/063,197

(22) Filed: Feb. 25, 2025

(30) Foreign Application Priority Data
Feb. 26, 2024 (TW) 113106788

(51) Int. Cl. H01H 13/52; H01H 13/04; H01H 13/10; H01H 13/70

(52) U.S. Cl. CPC H01H 13/52; H01H 13/04; H01H 13/10; H01H 13/7006

(57) ABSTRACT

A keyswitch includes a keycap, a lifting mechanism and a bottom board. The lifting mechanism is movably connected under the keycap and has a connection shaft. The bottom board has a hole structure and is located under the lifting mechanism. A hook structure is bent from a side wall of the hole structure toward the connection shaft. The connection shaft is movably connected to the hook structure to make the keycap movable upward and downward relative to the bottom board via the lifting mechanism. A first reinforcement area extends in a tapered manner outward from a bent side of the hook structure along the side wall.

### BACKGROUND OF THE INVENTION

### 1. Field of the Invention

The present invention relates to a keyswitch, and more specifically, to a keyswitch forming a reinforcement area from a root portion of a hook structure of a bottom board.

### 2. Description of the Prior Art

A keyboard, which is the most common input device, can be found in variety of electronic apparatuses for users to input characters, symbols, numerals and so on. Furthermore, consumer electronic products and industrial machine tools are all equipped with a keyboard for performing input operations.

A conventional keyswitch structure used in a notebook computer usually utilizes a lifting mechanism (e.g., a scissor-type support mechanism) to provide support and vertical movement for a keycap. Connecting structures are disposed on the keycap and a bottom board for connecting to the lifting mechanism. In a conventional bottom board design, to save space, the bottom board directly forms the connecting structures for rotatably connecting to the lifting mechanism. In the prior art, hook structures are usually formed on the bottom board by stamping a metal sheet. As shown in FIG. 1, a hook structure 1 is bent from a side wall W of a hole structure 4 on a bottom board 3 toward a keycap, with a rectangular cantilever structure 5 formed between a root portion 2 of the hook structure 1 and the side wall W. However, when a lifting mechanism needs to be assembled or disassembled, the hook structure 1 usually receives a pulling force, so as to easily cause deformation of a bent portion of the rectangular cantilever structure 5.

### SUMMARY OF THE INVENTION

Therefore, one purpose of the present invention is to provide a keyswitch forming a reinforcement area from a root portion of a hook structure of a bottom board, for solving the aforesaid problems.

According to an embodiment, a keyswitch of the present invention includes a keycap, a lifting mechanism, and a bottom board. The lifting mechanism is movably connected under the keycap and has at least one connection shaft. The bottom board is located under the lifting mechanism and has at least one hole structure. At least one hook structure is bent from a side wall of the at least one hole structure toward the at least one connection shaft, and the at least one connection shaft is movably connected to the at least one hook structure to make the keycap movable upward and downward relative to the bottom board via the lifting mechanism. A first reinforcement area extends in a tapered manner outward from a bent side of the at least one hook structure along the side wall.

In summary, compared with the prior art where the hook structure is bent to form the rectangular cantilever structure, the design of extending the reinforcement area from the root portion of the hook structure in the present invention improves the deformation resistance of the hook structure. This effectively prevents deformation of the hook structure during assembly or disassembly operations with the connection shaft of the lifting mechanism due to structural pulling or pushing forces. Thus, the present invention can efficiently solve the prior art problem that deformation of the hook structure occurs easily at the root portion of the hook structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partial enlarged diagram of a bottom board according to the prior art.

FIG. 2 is a diagram of a keyboard according to an embodiment of the present invention.

FIG. 3 is a partial exploded diagram of a keyswitch in FIG. 2.

FIG. 4 is a top view of a lifting mechanism being connected to a bottom board.

FIG. 5 is a partial enlarged diagram of the bottom board in FIG. 3.

FIG. 6 is a top view of the bottom board in FIG. 5.

FIG. 7 is an enlarged diagram of a hook structure according to another embodiment of the present invention.

### DETAILED DESCRIPTION

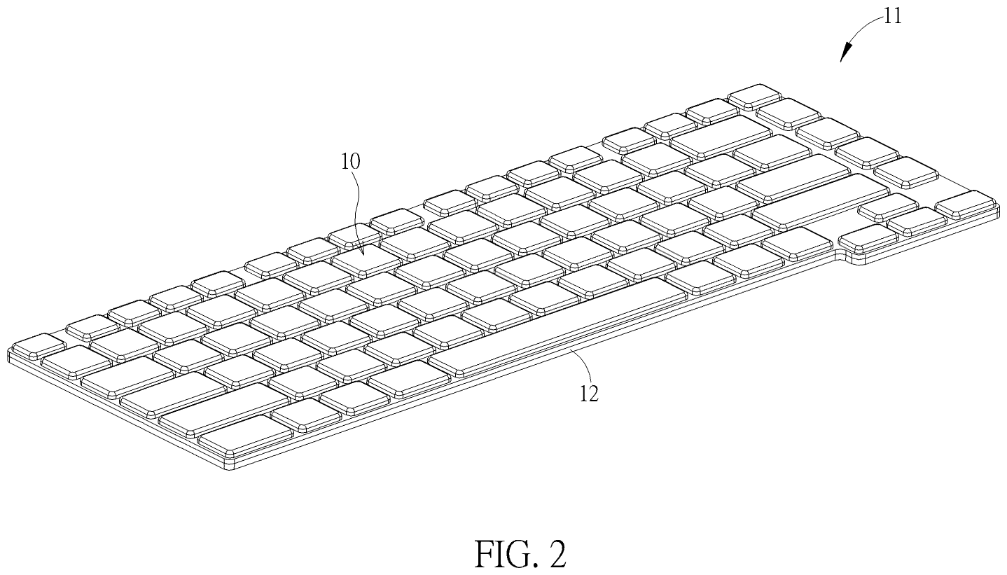

Please refer to FIG. 2, which is a diagram of a keyboard 11 according to one embodiment of the present invention. As shown in FIG. 2, the keyboard 11 includes a plurality of keyswitches 10 and a bottom board 12. The plurality of keyswitches 10 is disposed on the bottom board 12 for a user to press, thereby executing a desired input function. The keyboard 11 could be preferably a general keyboard device for personal computers, but the present invention is not limited thereto. For example, the keyboard 11 could also be applied to a portable electronic device with a foldable mechanism composed of an upper cover and a lower casing (e.g., a notebook or a foldable keyboard).

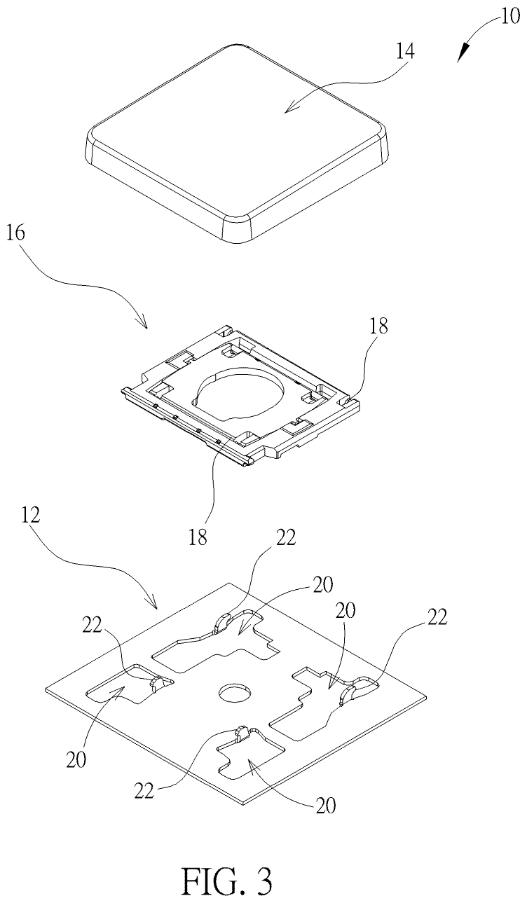

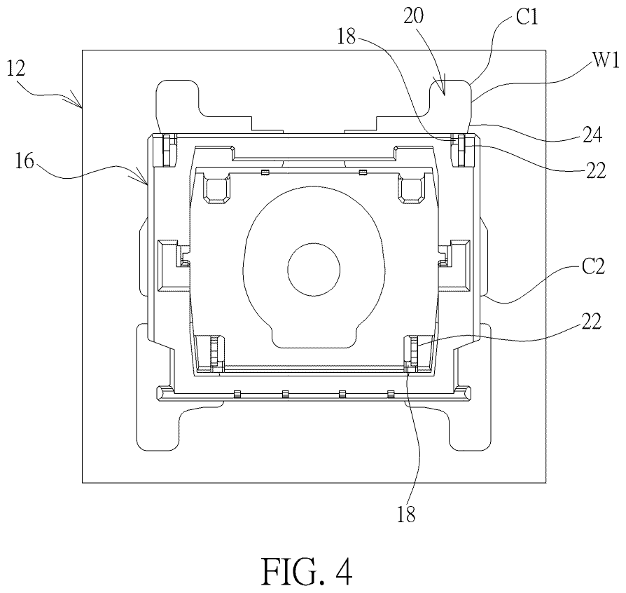

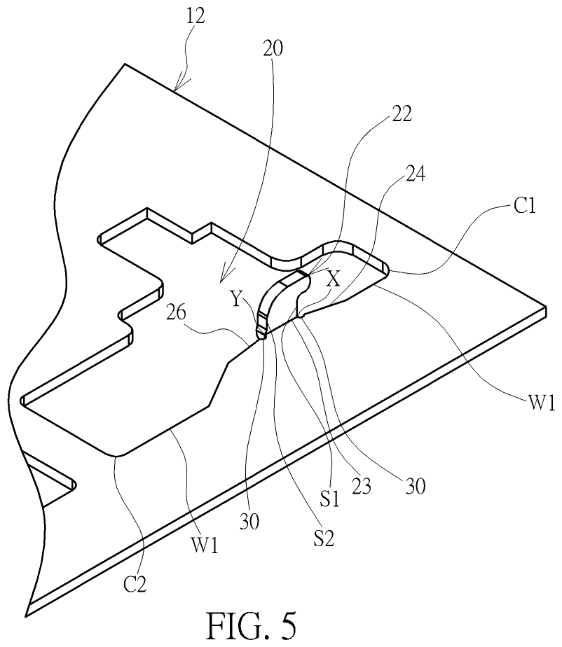

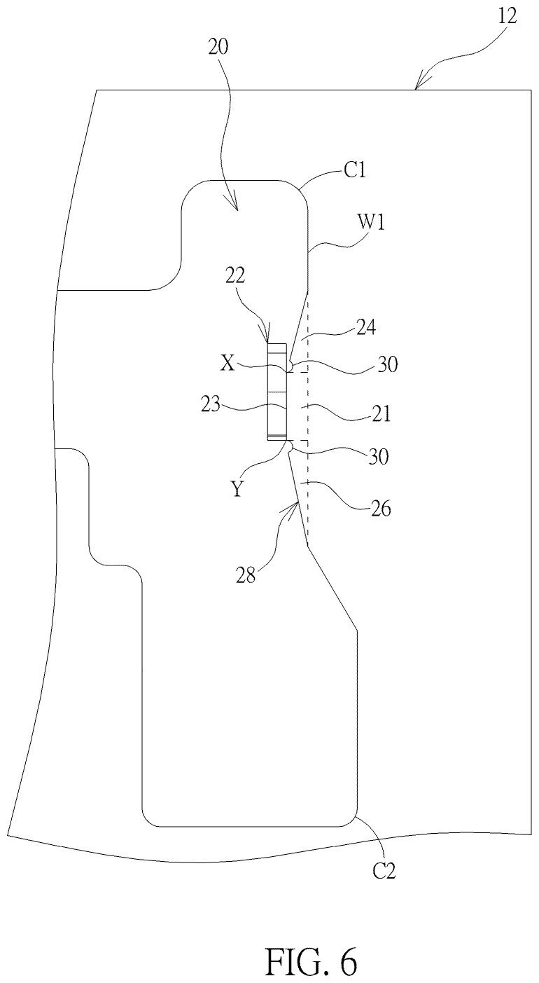

The hook structural design provided by the present invention could be applied to at least one of the plurality of keyswitches 10, wherein the actual number of hooks depends on the practical assembly and manufacturing requirements of the keyboard 11. For simplicity, more detailed description for one keyswitch 10 adopting the hook structural design is provided as follows. As for the related description for the other keyswitches 10 adopting the hook structural design, it could be reasoned by analogy and omitted herein. Please refer to FIGS. 3, 4, 5, and 6. FIG. 3 is a partial exploded diagram of the keyswitch 10 in FIG. 2. FIG. 4 is a top view of a lifting mechanism 16 being connected to the bottom board 12. FIG. 5 is a partial enlarged diagram of the bottom board 12 in FIG. 3. FIG. 6 is a top view of the bottom board 12 in FIG. 5. As shown in FIGS. 3, 4, 5, and 6, the keyswitch 10 includes the bottom board 12, a keycap 14, and the lifting mechanism 16. The bottom board 12 could include at least one hole structure 20 (four shown in FIG. 3, but not limited thereto, meaning that the number of hole structures depends on the connection configuration between the lifting mechanism 16 and the bottom board 12) and is located under the lifting mechanism 16. The lifting mechanism 16 preferably adopts a scissor-type lifting mechanical design (but not limited thereto, meaning that the present invention could adopt other lifting mechanical design, such as a butterfly-type lifting mechanical design). The lifting mechanism 16 is movably connected beneath the keycap 14 and includes at least one connection shaft 18 (two shown in FIG. 3, but not limited thereto) movably connected to the hook structure 22 of the bottom board 12 (e.g., a movable connection mechanism as shown in FIG. 4, but not limited thereto), allowing the keycap 14 to move upward and downward relative to the bottom board 12 via the lifting mechanism 16. As a result, when the keycap 14 is pressed, the keyboard 11 can perform a desired input function.

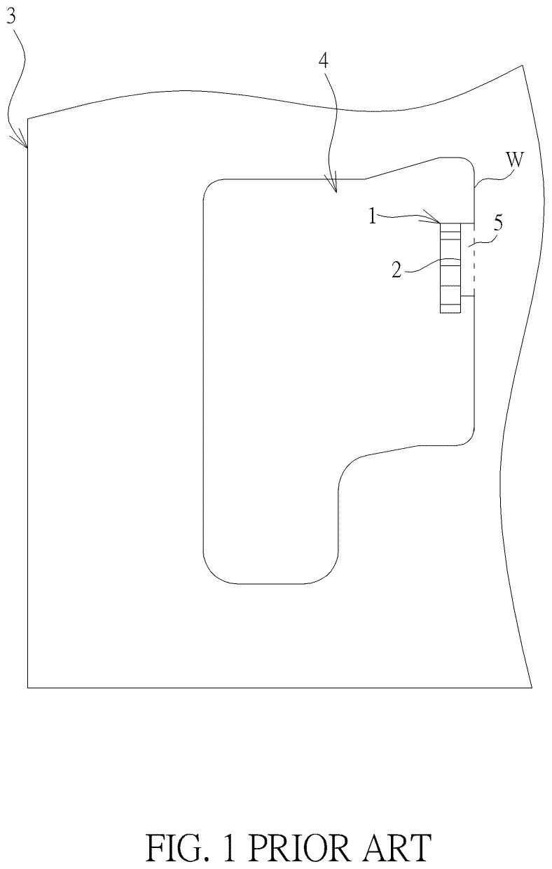

Detailed description for the reinforcement structural design of one of the hook structures 22 on the bottom board 12 is provided as follows. As for the related description for the other hook structures 22 adopting the reinforcement structural design, it could be reasoned by analogy and omitted herein. As shown in FIGS. 3, 4, 5, and 6, the hook structure 22 could be bent from a side wall W1 of the hole structure 20 toward the connection shaft 18 and could adopt a root reinforcement structural design. More specifically, as shown in FIGS. 5 and 6, in this embodiment, a rectangular area 21 is formed between a root portion 23 of the hook structure 22 and the side wall W1 of the hole structure 20. A first reinforcement area 24 extends in a tapered manner from a junction X between a bent side S1 of the hook structure 22 and the root portion 23 along the side wall W1 toward a first corner C1 of the hole structure 22. Similarly, a second reinforcement area 26 extends in a tapered manner from a junction Y between another bent side S2 of the hook structure 22 and the root portion 23 along the side wall W1 toward a second corner C2 of the hole structure 22. Preferably, both the first reinforcement area 24 and the second reinforcement area 26 are in a tapered bevel shape (but not limited thereto, meaning that the present invention could adopt other tapered structural design, such as a tapered concave/curved surface design) to cooperatively form a trapezoidal cantilever structure 28 with the rectangular area 21 at the root portion 23 of the hook structure 22. In such a manner, compared with the prior art where the hook structure is bent to form the rectangular cantilever structure (as shown in FIG. 1), the design of extending the reinforcement area from the root portion 23 of the hook structure 22 in the present invention improves the deformation resistance of the hook structure 22. This effectively prevents deformation of the hook structure 22 during assembly or disassembly operations with the connection shaft 18 of the lifting mechanism 16 due to structural pulling or pushing forces. Thus, the present invention can efficiently solve the prior art problem that deformation of the hook structure occurs easily at the root portion of the hook structure.

To be noted, as shown in FIG. 5, the first reinforcement area 24 could selectively be designed to further taper and extend toward the first corner C1 (and could even extend directly to the first corner C1). Similarly, the second reinforcement area 26 could selectively be designed to further taper and extend toward the second corner C2 (and could even extend directly to the second corner C2), thereby enhancing the structural reinforcement effect by increasing the extension area of the trapezoidal cantilever structure 28, and further improving the deformation resistance of the hook structure 22. In practical applications, a groove 30 is formed at a position where the first reinforcement area 24 is connected to the hook structure 22, and another groove 30 is formed at a position where the second reinforcement area 26 is connected to the hook structure 22. Preferably, the aforesaid grooves are in a semicircular shape (as shown in FIG. 6, but not limited thereto) for providing overflow accommodation space, so as to prevent deformation and stress concentration in the hook structure 22 during the stamping and bending processes.

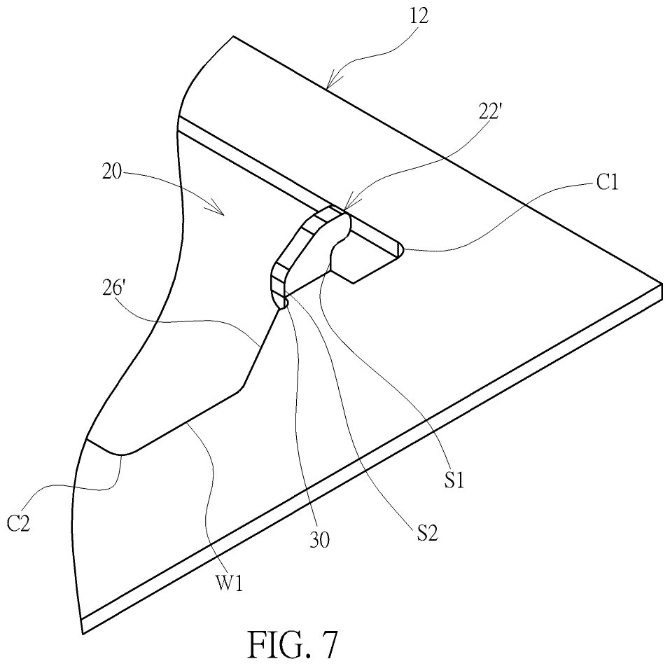

It should be mentioned that the reinforcement structural design of the present invention is not limited to the aforesaid dual-sided reinforcement design, meaning that the present invention could adopt a single-sided reinforcement design. For example, please refer to FIG. 7, which is an enlarged diagram of a hook structure 22′ according to another embodiment of the present invention. Components both mentioned in this embodiment and the aforesaid embodiments represent components with similar structures or functions, and the related description is omitted herein. In this embodiment, as shown in FIG. 7, a second reinforcement area 26′ extends outward in a tapered manner from the bent side S2 of a hook structure 22′ along the side wall W1, but the present invention is not limited thereto, meaning that the present invention could adopt another single-sided reinforcement design in which the first reinforcement area extends outward in a tapered manner from the bent side of the hook structure along the side wall as mentioned above. Preferably, the second reinforcement area 26′ is in a tapered bevel shape (but not limited thereto, meaning that the present invention could adopt other tapered structural design, such as a tapered concave/curved surface design). Via the aforesaid design of extending the one-sided reinforcement area from the root portion of the hook structure, the deformation resistance of the hook structure 22′ can be effectively enhanced, so as to prevent deformation of the hook structure 22′ during assembly or disassembly operations with the connection shaft 18 of the lifting mechanism 16 due to structural pulling or pushing forces. Thus, the present invention can efficiently solve the prior art problem that deformation of the hook structure occurs easily at the root portion of the hook structure. As for other derived designs of the hook structure 22′ (e.g., the groove design and the design in which the reinforcement area extends in a tapered manner toward the corner of the hole structure), the related description could be reasoned by analogy according to the aforesaid embodiments and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyswitch comprising:
a keycap;
a lifting mechanism movably connected under the keycap and having at least one connection shaft; and
a bottom board located under the lifting mechanism and having at least one hole structure, at least one hook structure being bent from a side wall of the at least one hole structure toward the at least one connection shaft, and the at least one connection shaft being movably connected to the at least one hook structure to make the keycap movable upward and downward relative to the bottom board via the lifting mechanism, wherein a first reinforcement area extends in a tapered manner outward from a bent side of the at least one hook structure along the side wall.

2. The keyswitch of claim 1, wherein the first reinforcement area extends in a tapered manner toward a first corner of the at least one hole structure opposite to the bent side.

3. The keyswitch of claim 1, wherein the first reinforcement area is in a tapered bevel shape.

4. The keyswitch of claim 1, wherein a groove is formed at a position where the first reinforcement area is connected to the at least one hook structure.

5. The keyswitch of claim 1, wherein a second reinforcement area extends in a tapered manner outward from another bent side of the at least one hook structure along the side wall.

6. The keyswitch of claim 5, wherein the first reinforcement area extends in a tapered manner toward a first corner of the at least one hole structure opposite to the bent side, and the second reinforcement area extends in a tapered manner toward a second corner of the at least one hole structure opposite to the another bent side.

7. The keyswitch of claim 5, wherein the first reinforcement area and the second reinforcement area are in a tapered bevel shape to cooperatively form a trapezoidal cantilever structure with a root portion of the at least one hook structure.

8. The keyswitch of claim 5, wherein a groove is formed at a position where the first reinforcement area is connected to the at least one hook structure, and another groove is formed at a position where the second reinforcement area is connected to the at least one hook structure.
